(19) United States
(12) Patent Application Publication
(10) Pub. No.: US 2006/0041581 A1
(43) Pub. Date: Feb. 23, 2006

(54) Method of discovering contact identifiers for network access devices

(75) Inventors: Abdol Hamid Aghvami, London (GB); Paul Anthony Pangalos, London (GB)

Correspondence Address: KELLEY DRYE & WARREN LLP, TWO STAMFORD PLAZA, 281 TRESSER BOULEVARD, STAMFORD, CT, 06901, US

(73) Assignee: King's College London, London (GB)

(21) Appl. No.: 11/206,559

(22) Filed: Aug. 18, 2005

(30) Foreign Application Priority Data
Aug. 18, 2004 (GB) 0418411.5

(51) Int. Cl. G06F 7/00

(52) U.S. Cl. 707/102

(57) ABSTRACT

A method of discovering a contact identifier by which data may be sent over one or more electronic data communication network (10) toward one or more network access device (14-20) used by a user (21), which method comprises the steps of: (a) electronically collecting a contact identifier from said one or more network access device, and storing said contact identifier in memory, which contact identifier provides an indication of the addressing option(s) available on the or each network access device; (b) generating an electronic database comprising or comprising a reference to said contact identifier; and

(c) providing access to said electronic database whereby said user (21) and/or another user may obtain said contact identifier, whereby said user and/or another user may discover said addressing option(s) to facilitate transmission of data toward said one or more network access device (14-20).

### CROSS-REFERENCE TO RELATED APPLICATIONS

This application claims foreign priority benefits under 35 USC 119 of patent application GB 0418411.5, filed Aug. 18, 2004, which disclosure incorporated herewith by reference in its entirety.

### FIELD OF THE INVENTION

The present invention relates to a method of discovering a contact identifier by which data may be sent over one or more electronic data communication network toward one or more network access device of a user, a network access device, a network node, a computer program, a computer program product, to a method of identifying an interface on a remote electronic data communication network, and to a method of assisting network selection for a multimode network access device.

### BACKGROUND OF THE INVENTION

An ever increasing number of electronic network access devices are being manufactured with the ability to send and receive electronic data over external data communication networks such as the Internet, mobile telephone (or cellular) networks, digital video broadcast networks (DVB), wireless local area networks (W-LANs) etc. All manner of devices are being designed and manufactured with some ability to communicate (either actively and/or passively) with one or more such external network and it is highly likely that this trend will increase in the future. Such devices include mobile telephones, personal digital assistants, notebook computers, televisions, radios, personal stereo equipment, fridges and clothing to name but a few.

There are many kinds of external network with which devices are intended to communicate. Usually however devices are primarily intended to use one particular network. For example, notebook computers may comprise a wireless network interface card enabling communication with an access point (a radio transceiver), a mobile telephone comprises an interface for communication with base stations that are part of the mobile telephone infrastructure, a computer may have a wired connection with the local telephone exchange by means of which it can access the Internet or other computer network, and a set top box may have an interface for receiving data over a digital video broadcast network. An application or “service” on each device provides a means by which the device may send data to and receive data from an electronic data communication network. For example, there may be an instant messaging service, an SMS text messaging service and a voice service available on one network access device.

However, some devices are being made with more than one interface, and their number is expected to increase in the future. Such “multi-mode” devices have the ability to communicate with more than one external network, usually at the choice of the user.

However, some devices are being made with more than one interface, and their number is expected to increase in the future. Such “multi-mode” devices have the ability to communicate with more than one external network, usually at the choice of the user.

In the future it is expected that devices will also be able to switch between heterogeneous networks either under control of the user or automatically in response to parameters such as cost, bandwidth and offered services etc. To the best of the applicant's knowledge and belief there is no mechanism for a user to discover and track his or her devices and the services available thereon, in a heterogeneous network environment.

At present there are a number of so-called “presence” protocols that permit users to exchange information (such as availability) and instant messages. Such software includes the well known AOL Instant Messenger and Yahoo Instant Messenger. These applications allow users to exchange instant messages and to inform “buddies” (i.e. friends using the same software) of changes in status. A user is able to choose such statuses as “Available”, “Busy”, “On the Phone”, etc. This status information is passed to the buddies of the user so that they may know when it is convenient to contact the user.

The presence functionality is provided via one application on the device permitting buddies of the user to see the status of the user, but no information is provided about other services the user has available on that particular device by which he may be contacted. As explained above a “service” may mean one or more application by means of which the user can be contacted.

It would also be desirable if other devices and the services on those devices could be made available to buddies of the user for example. Furthermore, this would enable the user himself to keep track of his devices and to set which services and on which devices he may be contacted at particular times for example.

It would also be desirable if the user were able to readily obtain the means of contacting (i.e. sending data to) some or all of his devices on all of the different networks that those devices might use.

US 2003/0217142 (Bobde et al.) discloses a system for detecting and communicating the presence of multiple computing devices of a single user. Each device generates presence information that is transmitted to a server. The server aggregates all of the information and passes it to another user who can then see the devices of the user and the user presence status associated therewith. Presence information is said to include any data that specifies the availability, proximity, activity level or operating state of a computing device or corresponding user of the device. Therefore any third party wishing to contact the user must already know the necessary address(es) to which any message must be sent. This document does not address the problems of providing the actual means of contacting different services on each device, particularly in a heterogeneous network environment.

### SUMMARY OF THE PRESENT INVENTION

According to the present invention there is provided a method of discovering a contact identifier by which data may be sent over one or more electronic data communication network toward one or more network access device used by a user, which method comprises the steps of:

(a) electronically collecting a contact identifier from said one or more network access device, and storing said contact identifier in memory, which contact identifier provides an indication of the addressing option(s) available on the or each network access device and/or for said user;

(b) generating an electronic database comprising or comprising a reference to said contact identifier; and

(c) providing access to said electronic database whereby said user and/or another user may obtain said contact identifier, whereby said user and/or another user may discover said addressing option(s) to facilitate transmission of data toward said one or more network access device. The other user may be an individual, network operator, content provider, service provider, etc. In one embodiment step (a) is performed in a heterogeneous (e.g. a Digital Video Broadcast, an IP network and a cellular network) environment and the contact identifier from each collected together in the electronic database. In this way substantially all of the available contact identifiers for a user can be stored in, accessed and/or transmitted from the electronic database. Step (c) may be carried out by said user and/or other users remotely accessing said electronic database. Preferably however, access to said electronic database is facilitated by transmitting the relevant contact identifier(s) associated with a particular user from a network node storing said database on a first electronic data communication network to one or more network node on other electronic data communication networks. The network nodes on the other electronic data communication networks may then distribute and/or store (or otherwise make accessible) the contact identifier(s) for retrieval by network access devices of said user or other users on those networks. In one aspect the method is repeated whereby the database comprises real-time, up to date and/or last known contact identifier(s) of the user. The method may be repeated substantially continuously whereby the database contains substantially only those contact identifiers used by the user at any one time. In this way the electronic database is dynamic, containing data representing substantially only contact identifiers useable to facilitate contact of the user at that time.

The contact identifier may comprise one or more contact address available on the network access device. The contact address may be a software address, hardware address, packet-switched address or a circuit switched address (e.g. telephone number) for example. As such the addressing option(s) may comprise some or all of the addresses by which the network access device may be contacted remotely. The addressing option(s) may include: addresses at the application layer (e.g. e-mail, SIP, URI, FTP instant messaging user ID); addresses at the transport layer (e.g. TCP/UDP port numbers), addresses at the network layer (e.g. IP addresses: unicast, multicast, etc.); and/or addresses at the link layer (e.g. MAC, PID). The address may also be those addresses which do not directly reach the network access device, but which are obtainable using the network access device. For example if an e-mail is sent to a web-based e-mail address (e.g. Yahoo, Hotmail), the e-mail does not directly address the network access device, but is obtainable by the network access device when the user logs on to his e-mail account using a web browser on the device. Such contact addresses may be included in the contact identifier.

The contact identifier preferably comprises only those contact addresses that are presently available on each network access device of the user. In this way another user can discover only those contact identifiers that will actually work and/or that the user has specified at that point in time.

Furthermore the contact identifier may comprise a communication identifier of the or each presently available communication entity or entities on each network access device. The communication entity may be any service, application or interface (e.g. e-mail application, cellular interface) by which data may be sent/received by the network access device. In one embodiment the communication identifier may be inferred from the contact address; for example if the contact address takes the form 07100 123456 it may be assumed that the network access device has a cellular interface and the appropriate communication identifier may be stored in the database.

“Contact identifier” may mean any service, interface and/or electronic address by which user may be reached. A service may mean any communication entity (e.g. software application) stored on a network access device that functions to transmit data to and/or receive data from and electronic data communication network. A network access device may have access to more than one service for accessing more than one electronic data communication network. An electronic address may mean an e-mail address, SIP address, hardware interface address (e.g. IP or MAC address), a cellular telephone number, etc. A network access device may mean any electronic hardware having one or more interface to which data may be sent from a remote electronic data communication network. In the future this will be an extremely wide range of products e.g. mobile telephones, personal digital assistants (PDAs), portable and personal computers, televisions, DVD players and recorders, hard disk drive television recorders, hi-fi equipment, computer peripheral devices (e.g. printers, scanners), personal music players, cameras, fridges, fish tanks, and clothing. The invention provides a means for a user to track the contact identifiers for substantially all such devices that he or she owns or has access to, which devices are distributed over heterogeneous networks. In this way it will be possible to quickly and easily select a device and contact it assisted by the contact identifier stored in the electronic database. For example, a user at may remotely contact and configure a DVD recorder at home to record a program or switch their central heating on/off. A user may mean an individual, a group of users, a company, a university, etc.

In one embodiment, said contact identifier comprises substantially all of the currently available addressing options available on the or each network access device of said user.

Advantageously, said contact identifier comprises contact addresses for sending/receiving data to/from said network access devices over different electronic data communication networks. The different networks may be heterogeneous for example a cellular network and a DVB network. “Heterogeneous” may mean networks that utilise incompatible access technologies that are under different administrative domains but which may provide coverage in the same physical space. An administrative domain may be those networks that are under control of one network operator. A network operator may be a company, a group of companies, etc. that is responsible for development, provision and maintenance of one or more electronic data communication network accessible by users, and usually who invoices those users for that access.

Preferably, the method further comprises the step of transmitting said contact identifier from said electronic database to a network access device whereby upon receipt of said contact identifier, a user of that network access device is informed of said contact identifier. The transmission may be direct or indirect. The contact identifier may be transmitted using any suitable message format, for example, as a payload in an IP packet or UDP datagram. The message may be addressed to the network access device of a user or users wishing to know a contact identifier of that particular device or all of the available contact identifiers of a user or user's environment which may be part of one network or a number of networks for example.

Advantageously, said contact identifier represents a plurality of contact addresses by which data may be sent to a number of different network access devices, each having access to at least one electronic data communication network. For example the contact identifier may represent an e-mail address accessible by a PC and a PDA, a hardware interface address (e.g. IP or MAC address) of a set-top box on a DVB network and a cellular telephone number. The PC has access to the IP network (e.g. Internet), the PDA has access to the IP network and a cellular network, and the set-top box has access to a DVB network.

Preferably, the method further comprises the step of mapping a static identifier (PGI) of said user to said contact identifier, whereby said electronic database comprises a mapping between a user and one or more ways of sending data to said user over one or more electronic data communication network. Preferably, the static identifier should be able to identify a user over all of the networks used by that user. It may take the form PGI:paul@kcl.ac.uk i.e. similar to a SIP (Session Initiation Protocol) address. When configuring a network access device, the user may be required to input their static identifier so that the contact identifier may be associated therewith when gathered from the device.

Advantageously, the method further comprises the step of storing in said electronic database a mapping between said static identifier and one or more buddy of said user, whereby a network access device of said one or more buddy may access and/or receive said contact identifier from said electronic database so that said one or more buddy may be informed of said contact identifier for said user. A buddy may mean a contact (e.g. friend, customer, relative) of the user who wishes to know how that user may be contacted. In this way the buddy can see all of the available ways of contacting the user and may chose to use whichever. Data representing the ways of contacting the user may be sent to a third party (e.g. network operator, service provider) network entity that wishes to gather and store data about the user's environment i.e. the devices and contact identifier for each.

Preferably, the method further comprises the steps of monitoring said contact identifier with time, and updating said contact identifier in said electronic database upon detection of a change in status of said addressing option(s). Such a change may be when the user goes offline or online, when a new application is started up or shut down on a network access device, when new network access device switched on or turned off, or when the available network coverage of that device is changed, etc. When each network access device notices such a change it should inform the electronic database which will then advise any buddies of the user and/or third party entity of the change. In this way not only can other users see devices of the user, but they can also see the available services on each network access device by which that user may be contacted.

Advantageously, the method further comprises the step of electronically gathering and storing environment data representing a physical environment in which a network access device of said user is located. Environment data may mean data representing a physical location of the device, when a network access card is inserted or removed from the device, etc.

Preferably, each network access device of a user performs said collection step of step (a). In one embodiment each network access device gathers details of the contact address(es) from each service available on that device and transmits this data to the network where a logical entity gathers the information together for all devices of that user.

Advantageously, said collection step comprises the steps of (i) receiving or otherwise obtaining from a communication entity on said network access device, which communication entity provides a means for transmitting data to and receiving data from an electronic data communication network, an entity identifier of said communication entity and a contact address for contacting said user via that communication entity, and (ii) storing said data in a memory as said contact identifier. The memory may be a magnetic recording medium, for example a hard disk, or an integrated circuit memory such as RAM.

Preferably, the method further comprises the steps of electronically gathering and storing in said memory environment data representing a physical environment in which said network access device is presently located.

Advantageously, the method further comprises the step of associating a static identifier (PGI) of the user of said communication entity with said contact identifier, which static identifier serves to identify the user over all electronic data communication networks used by the user. In this way the contact identifier is recognisable by the electronic data communication networks as associated with a particular user.

Preferably, the method further comprises the step of electronically gathering data representing other communication entities available on said network access device and storing said data in said memory. Such other services may include audio, video, etc.

Advantageously, the method further comprises the step of forming an electronic message comprising said contact identifier and transmitting said electronic message to an electronic data communication network associated with said communication entity. The electronic message may comprise text data representing the contact identifier and other capabilities of the network access device. The electronic message may be sent using a suitable transport protocol such as SIP.

Preferably, the method further comprises the step of transmitting said electronic message to each electronic data communication network accessible by the or each communication entity on said network access device. Where a network access device has access to more than one network, for example a PDA with access to an IP network and a cellular network, it will be necessary to advise each network of the contact identifier for that network. For the previous example this might be by advising the IP network of an e-mail address and advising the cellular network of the telephone number.

Advantageously, said electronic message comprises text data representing said contact identifier.

Preferably, the method further comprises the step of monitoring said network access device for the addition and removal of a communication entity therefrom, and upon addition or removal thereof transmitting an electronic update message to the or each electronic data communication network accessible by that service. Addition and removal of communication entities may include insertion of a network card, or when a service is started or stopped, etc.

Advantageously, a network node in communication with said electronic data communication network performs step (b). In one embodiment a logical entity on the electronic data communication network performs this step.

Preferably, step (b) comprises the steps of receiving on a first electronic data communication network said contact identifier from a network access device, which contact identifier is accompanied by a static identifier (PGI) of said user, and determining whether or not said first electronic data communication network is a home network of said user.

Advantageously, said static identifier comprises a domain and said determining step comprises examining a domain of said first electronic data communication network against the domain of said static identifier. The domain may represent an interface e.g. an IP address such as the domain “kcl.ac.uk” that provides access to one or more interface in that domain.

Preferably, the method further comprises the step of if said first electronic data communication network is not said home network, forwarding said contact identifier to a second electronic data communication network that is said home network. The static identifier may provide the means to forward the contact identifier to said home network. The home network may be that network of the user that is responsible for billing the user. Alternatively, it may be a network that is chosen by the user.

Advantageously, the method further comprises the step of if said first electronic data communication network is said home network, storing said contact identifier in a memory and adding said contact identifier to said electronic database. Where the first electronic data communication network is the home network, it is not necessary to forward the contact identifier any further. The home network will gather and store all of the contact identifiers received from other networks such that the electronic database will contain a summary of substantially all of the devices, communication entities/services and contact addresses by which a user may be contacted.

Preferably, the method further comprises the step of storing a mapping between said static identifier and said home network, whereby said contact identifier may be routed from said first electronic data communication network to said home network. Another logical entity on the electronic data communication network may be responsible for routing data toward the home network. This entity may be separate and distinct from the entity storing the electronic database. In this way the storing and routing functions may be separated such that a server on the home network may store the database and a SIP proxy server may perform the routing function for example.

Advantageously, the method further comprises the steps of storing a mapping between said static identifier and a list of one or more buddy of said user, and upon receipt of said contact identifier, transmitting or otherwise making accessible said contact identifier to said one or more buddy or a third party entity.

Preferably, the method further comprises the step of assisting network selection for a multi-mode access device by sending electronic requests to the electronic data communication networks accessible by that device, which electronic requests each comprise parameters required by said multi-mode network access device and a network identifier of each electronic data communication network accessible from that device, and awaiting responses from said electronic data communication networks. In this way the networks can advise of their ability to serve the user based on the user's requirements. A multi-mode access device may be any such device as mentioned above which has access to more that one electronic data communication network. For example, a PDA with access to a WLAN and a cellular network is a multi-mode access device. Some network access devices are adaptable so that they can use more than one network. For example various network access cards can be inserted into network access devices for this purpose.

Advantageously, the method further comprises the step of generating a network selection electronic message comprising a list of electronic data communication networks accessible from that network access device, and transmitting said network selection electronic message to an electronic data transmission network accessible by that device. In one embodiment the electronic request is sent to one electronic data communication network and that network generates the network selection message(s) and sends it to the other networks.

Preferably, the method further comprises the step of electronically searching a network database for a network contact for contacting each of said electronic data communication networks, which network database comprises a mapping between said network identifier of each electronic data communication network and said network contact. The network database may be stored in a computer (e.g. server) that is accessible by a network operator.

Advantageously, said network contact identifier comprises an IP or URI address of an interface on another electronic data communication network.

Preferably, the method further comprises the step of generating a network reply electronic message comprising a list of electronic data communication networks ranked by ability to meet said parameters, and transmitting said network reply electronic message to said multi-mode access device. The network access device may then act on the network reply electronic message to commence communication with one of the recommended networks.

The network selection steps above may be provided in the form of computer executable instructions on a computer program product such as a CD-ROM to be installed on a server for example. According to the present invention there is also provided a network node comprising such computer executable instructions. It will be appreciated that the network operator steps of the method may be supplied as a one computer program product and those steps of the method performed by a network access device may be supplied as another computer program product. Any computer program product mentioned herein may be embodied on a record medium, in a computer memory, in a read-only memory, or on an electrical carrier signal for example.

According to another aspect of the present invention there is provided for use in a method as set out above, a network access device that comprises a memory storing computer executable instructions for performing the network access device method steps set out above. Such network access device may include, but are not limited to, any of those mentioned herein.

According to another aspect of the present invention there is provided for use in a method as set out above, a first network node that comprises a memory storing computer executable instructions for performing the network node method steps set out above. Such a first network node may comprise a computer, such as a server, that is accessible by the electronic data communication network.

According to another aspect of the present invention there is provided for use in a method as set out above, a second network node that comprises a memory storing computer executable instructions for performing the network node method steps according to claim 12 to which reference is made. The second network node may be separate from the first network node and may comprise a SIP proxy server for example.

According to another aspect of the present invention there is provided a computer program comprising computer executable instructions for causing an electronic data communication network to perform the method steps as set out above.

According to another aspect of the present invention there is provided a computer program comprising computer executable instructions for causing a network access device to perform the network access device method steps set out above. Such a computer program may be provided from the electronic data communication and downloaded onto each network access device. Alternatively the network access device may comprise firmware provided by a manufacturer of the network access device, which firmware incorporates such computer executable instructions. The computer program may also be provided on a read-only memory, such as a CD-ROM, for installing onto a computer.

According to another aspect of the present invention there is provided a computer program comprising computer executable instructions for causing a first network node to perform the first network node method steps as set out above.

According to another aspect of the present invention there is provided a computer program comprising computer executable instructions for causing a second network node to perform the second network node method steps as set out above.

According to another aspect of the present invention there is provided a computer program product storing computer executable instructions in accordance with any of the aforementioned computer programs.

Such a computer program may be embodied on a record medium, in a computer memory, in a read-only memory, or on an electrical carrier signal for example.

A further problem with which the present invention is concerned is assisting users and/or their network access devices to select a network to use for a particular service. In a heterogeneous network environment, users have the choice of connecting a NAD to a diversity of different networks (usually by wireless link). NADs detect the different networks from beacon signals from base stations, etc. of the different networks. A user can choose which network to connect to based on signal strength for example. However, such a method is user centric i.e. based only on parameters within the user's device, and does not take into account network related information such as cost and bandwidth. Thus by selecting a network based on signal strength there is no guarantee that the user will have a higher throughput of data, or cheaper connection for example.

It is not practical or efficient for the network access device to contact each network for this purpose, as valuable resources including battery power and the radio resource would be consumed unnecessarily. Thus it would be beneficial if one of the networks to which a network access device has access could assist a user's selection of a network for a particular service. However, since each network is heterogeneous with respect to the others i.e. each uses different technologies (e.g. cellular, WLAN, DVB) under different administrative domains, it is not immediately apparent how one network would co-ordinate with the others for this purpose.

According to another aspect of the present invention there is provided in a first electronic data communication network having a first interface, a method of identifying a second interface in a second electronic data communication network, to which second interface data is to be sent from said first interface, which method comprises the steps of:—

(a) receiving on said first electronic data communication network electronic data representing a network identifier of said second electronic data communication network, which network identifier uniquely identifies an operator of said second electronic data communication network;

(b) electronically searching for said network identifier in an electronic database comprising data organised into a network identifier field and an address field, which electronic database provides a mapping between each network identifier and a respective address of an interface associated with that network identifier; and

(c) if said network identifier is located, providing an output signal comprising an address of said second interface, whereby data may be sent from said first interface to said second interface. Such method steps may be provided in the form of a computer program comprising computer executable instructions for causing a computer to perform said method steps. The computer program may be provided as a computer program product embodied on a record medium, in a read-only memory or in a carrier signal for example.

Advantageously, said first electronic data communication network and said second electronic data communication network are under different administrative domains respectively.

According to another aspect of the present invention there is provided a method of assisting network selection for a multi-mode network access device, which method comprises the steps of:—

(a) gathering data representing available interfaces on said multi-mode network access device, each interface permitting communication with a respective electronic data communication network;

(b) composing and transmitting an electronic message comprising a network identifier for each electronic data communication network accessible from that device, which electronic message is transmitted to a home electronic data communication network of said multi-mode network access device;

(c) said home electronic data communication network performing the steps above to identify an interface on each electronic data communication network accessible by said multi-mode network access device;

(d) said home electronic data communication network transmitting a request to each electronic data communication network accessible by said multi-mode network access device, which request message causes each electronic data communication network to determine an ability serve said multi-mode network access device and to respond to said home electronic data communication network accordingly;

(e) said home electronic data communication network composing and transmitting to said multi-mode network access device a response message comprising data representing said ability of each electronic data communication network accessible from said multi-mode network access device; and

(f) said multi-mode network access device awaiting said response from said electronic data communication network;

whereby on receipt of said response said multi-mode network access device or a user thereof may select one of said electronic data communication networks for a service on said multi-mode network access device based on data in said response. Method steps (a), (b) and (f) are to be performed by the multi-mode network access device (MMNAD), whereas steps (c), (d) and (e) are to be performed by the various networks. Accordingly those MMNAD steps may be provided in the form of a computer program comprising computer executable instructions for causing a MMNAD to perform said method steps. The computer program may be provided as a computer program product embodied on a record medium, in a read-only memory or in a carrier signal for example. The MMNAD may be stored in a computer memory on the network and downloaded to the MMNAD as an upgrade for example. Alternatively the MMNAD method steps may be placed on each MMNAD at point of manufacture by inclusion of suitable firmware for example.

Preferably, said multi-mode network access device further performs the step of gathering and transmitting in said electronic message a communication identifier that uniquely identifies a service desired by a user, and said request transmitted by said home electronic data communication network comprises said communication identifier, whereby the other electronic data communication networks determine an ability to provide said desired service.

Advantageously, said communication identifier identifies a service such as e-mail, Voice over IP, File Transfer Protocol, Web-browsing, Instant Messaging, Video and Audio.

Preferably, each communication identifier comprises a Quality of Service (QoS) parameter for each service.

Advantageously, said QoS parameter comprises service class (streaming, interactive, voice, background), maximum bit rate and/or maximum cost.

The network selection steps above ((c), (d) and (e)) may be provided in the form of computer executable instructions on a computer program product such as CD-ROM to be installed on a server for example. According to the present invention there is also provided a network node comprising such computer executable instructions. It will be appreciated that the network operator steps of the method may be supplied as a one computer program product and those steps of the method performed by a network access device may be supplied as another computer program product. Any computer program product mentioned herein may be embodied on a record medium, in a computer memory, in a read-only memory, or on an electrical carrier signal for example.

### BRIEF DESCRIPTION OF THE FIGURES

In order to provide a more detailed explanation of how the invention may be carried out in practice, preferred embodiments relating to use in a heterogeneous network environment will now be described, by way of example only, with reference to the accompanying drawings in which:—

FIG. 1 is a schematic representation of various network entities that are part of two electronic data communication networks for use in a method according to the present invention;

FIG. 2 is a schematic diagram of a network node in accordance with the present invention;

FIG. 3 is schematic diagram of a first embodiment of a user device in accordance with the present invention;

FIG. 4 is schematic representation of a user and their personal distributed environment, together with associated software modules, of FIG. 1;

FIG. 5 is a schematic representation of a registration procedure on a single network;

FIG. 6 is a schematic block diagram of the registration procedure of a network access device in accordance with the present invention;

FIG. 7 is a schematic representation of the addressing architecture for use in a device presence method according to the present invention;

FIG. 8 is a schematic representation of a registration procedure on the network of FIG. 1;

FIG. 9 is a schematic flow diagram of a device presence method according to the present invention;

FIG. 10 is a schematic diagram of a second embodiment of a user device in accordance with the present invention; and

FIG. 11 is a schematic diagram of a method of network selection in accordance with the present invention.

### DETAILED DESCRIPTION OF THE PREFERRED EMBODIMENTS

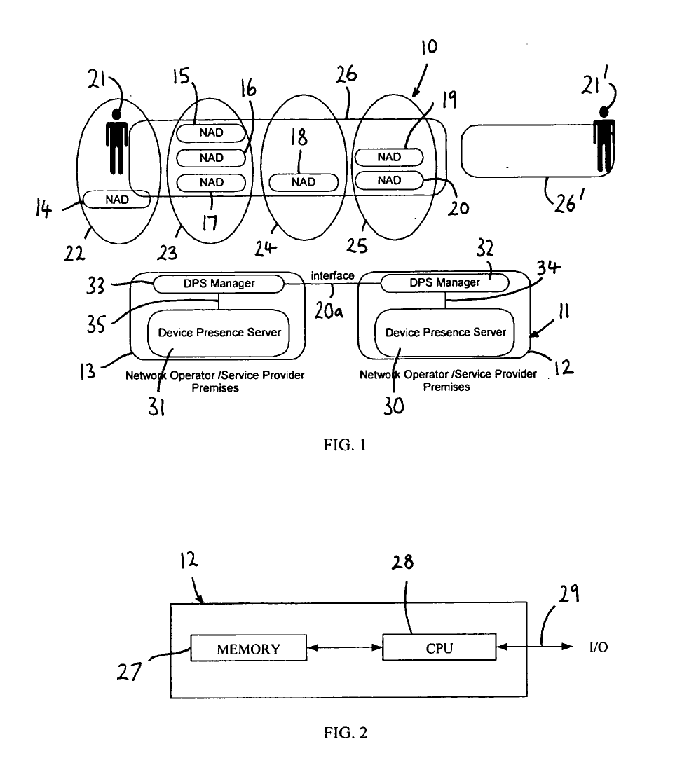

Referring to FIG. 1 part of two electronic data communication networks generally identified by reference numeral 10 comprise network infrastructure 11 that has network nodes 12, 13 and user Network Access Devices (NADs) 14-20. Electronic data may be sent from the network infrastructure 11 to the NADs 14-20 and vice versa. Network nodes 12, 13 are physically and logically separate and distinct and each is associated with a different network operator i.e. under different administrative domains. For example a Digital Video Broadcast (DVB) provider may operate the network node 12, and the network node 13 may be part of a Universal Mobile Telecommunications System (UMTS). Thus the network nodes 12, 13 are part of physically distinct communication networks. For the purposes of the present invention it is not necessary to illustrate or describe any other parts of the two communication networks, it being well known how electronic data may be transmitted to and/or from the network infrastructure 11 to the NADs 14-20 over a wireless or wired link (not shown).

The network nodes 12, 13 are able to communicate with one another over an interface 20a such as the Internet, a dedicated link or via a third party provider.

A user 21 has access to the NADs 14-20. The NADs 14-20 are a range of different communication devices such as a mobile telephone, a personal digital assistant (PDA), a personal computer, a set-top box (STB), a printer, a fridge, a fish tank, etc. It is sufficient that the user can access or log in to each device with an identity. Thus it is not necessary for the user to own each NAD. Each NAD is any device capable of communication with one or more remote network, be it via a wireless or wired communication link. The NADs 14-20 may be further divided into different user environments 22, 23, 24 and 25 as follows: the NAD 14 is a mobile telephone or PDA for example that is part of personal user environment 22; the NADs 15, 16 and 17 might be set top boxes, fridges, personal computers, etc. that are part of a home environment 23 of the user 21; the NAD 18 might be a car communication device that is part of a car environment 24 of the user 21; the NADs 19 and 20 might be a notebook computer and a telephone in a work environment 25 of the user 21. All of these environments are part of a larger personal distributed environment 26 of the user 20 that comprises all of the different user environments 22-25. Another user 21′ uses respective NADs (not shown) that are part of that user's personal distributed environment 26′.

Referring also to FIG. 2 each network node 12, 13 comprises a memory 27, a Central Processing Unit (CPU) 28 and an Input/Output (I/O) 29 by means of which electronic data may be sent to and received from external data communication networks and that may be processed, stored and retrieved, etc. By means of the memory 27 and CPU 28 each network node 12, 13 stores and executes computer executable instructions giving rise to a logical entity herein after called a Device Presence Server (DPS) 30, 31 and a logical entity herein after called a Device Presence Server Manager (DPSM) 32, 33. An interface 34 between the DPS 30 and DPSM 32, and an interface 35 between the DPS 31 and DPSM 33, permit exchange of data therebetween respectively.

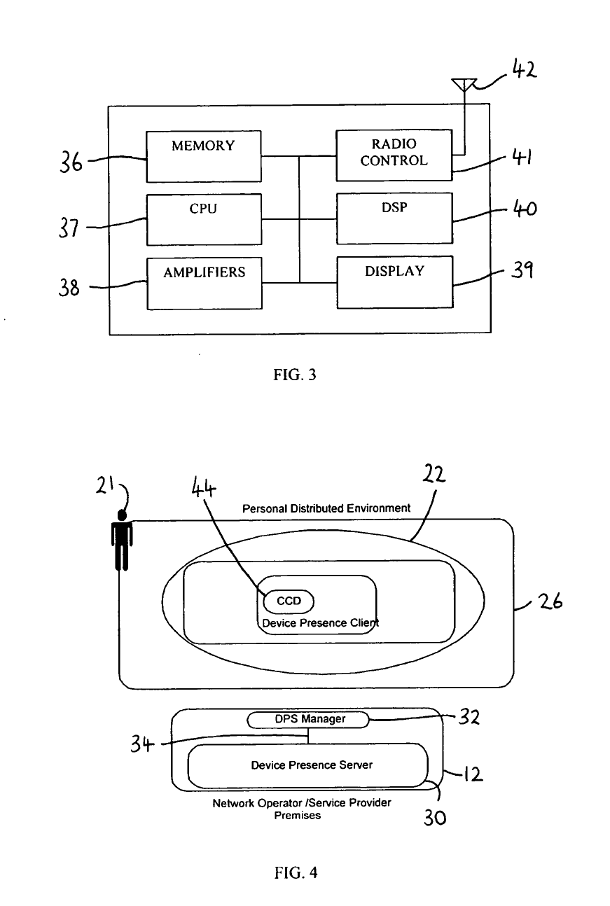

Referring to FIG. 3 part of the NAD 14 is shown in greater detail. It comprises a memory 36, a CPU 37, amplifiers 38, a display 39 (and an input not shown e.g. keyboard, touch-sensitive screen), digital-signal processing (DSP) 40, radio control 41 and an antenna 42. The aforementioned parts are in electronic communication with one another. In use, data may be sent to and received from the network infrastructure 11 by means of the antenna 42 over a wireless link. Data to be sent from an application running on the NAD 14 may for example be segmented and placed in IPv6 packets under control of the DSP 40 and CPU 37, framed and sent over the wireless link with a MAC protocol (e.g. IEEE 802.11b, Hiperlan 2, Bluetooth) by the radio control 41. Similarly data received from the network infrastructure over the wireless link is passed to radio control 41 where it de-framed, the IPv6 headers removed and the data ordered and passed up to the application level where it may be stored in the memory 36 and/or viewed on the display 39. It is to be noted the other NADs 15-20 may be different to that described above. For example a personal computer with a wired connection to an external network may not comprise the radio control 41 and antenna 42.

Referring also to FIG. 4 the memory 36 and CPU 37 store and execute computer executable instructions that give rise on the NAD 14 to a logical entity herein after referred to as a Device Presence Client (DPC) 43. The DPC 43 comprises a Communication and Contact Discovery Module (CCDM) 44 for discovering, capturing and storing a contact identifier comprising one or more device communication entity and/or contact address present on the NAD 14. The communication entity may be defined as a service comprising one or more application (i.e. end-user program or programs) by which communication to and/or from that device to remote networks is facilitated. The service may comprise one or more application. Such applications include e-mail, File Transfer Protocol (FTP), Web Browsers, Short Message Service (SMS), Instant Messaging (e.g., AOL Instant Messenger, Yahoo Instant Messenger), etc. The NADs 14-20 may or may not be IP (Internet Protocol) enabled. For a non-IP enabled NAD other transport protocols may be used such as multimedia messaging or WAP (Wireless Application Protocol).

Each communication entity installed on the NAD 14 will have one or more contact address by which data may be sent to that application by other users and network nodes. For example the contact identifier for e-mail is in the form username@example.com, FTP is an IP address followed by a port number, SMS is a telephone number and for a multimedia application it may be a SIP URI (Session Initiation Protocol Uniform Resource Identifier) such as sip:username@example.com. The contact address may also comprise a MAC address and or Packet Identifier (PID) by means of which Digital Audio and Video networks may address MPEG Transport Stream packets.

The discovering and capturing of data representing the communication entity and contact address may be performed by a suitable software interface that provides a means for the CCDM 44 to communicate with each service on the NAD 14. For example, when an application is started on the NAD 14, the application sends a message to the CCDM 44 advising of its online presence. The message comprises the application ID (i.e. an identity of the communication entity) and its contact address. The CCDM 44 responds with an acknowledgement. When the application is shut down it sends another message to notify the CCDM 44. In response the CCDM 44 will remove any stored data about that communication entity and set the status of the application as offline. Alternatively, the CCDM 44 may interrogate applications running on the NAD 14 and extract the necessary information. In this way existing applications can be supported.

In use, the CCDM 44 collects and collates contact identifiers comprising the communication entities and all of the contact addresses from all of the communication entities (applications) stored in the memory 36 of the NAD 14. This is done for all communication entities regardless of whether they are running or not (alternatively it may be done only for those communication entities that are running). The CCDM also stores data that signifies the status of each communication entity i.e. “on” or “off”. The CCDM 44 also adds an identifier to this information that identifies the user environment that the NAD 14 belongs to. This identifier may be provided by user input through the NAD 14, or it may be performed automatically. Such automatic identification of the user environment may be performed by analysing which applications the user is running, or by monitoring the SSID (Service Set Identifier) of an IEEE802.11 wireless link to which the NAD 14 has access for example. As the user moves between environments, the NAD 14 will detect different WLANs (Wireless Local Area Networks) and thereby different SSIDs. Other identifiers may be monitored in the same way to provide an indication of user environment, such as: a Bluetooth ID name for an application using a Bluetooth access point, a cell ID for an application using a cellular interface, and a DVB cell ID for a Digital Video Broadcast network, for example.

Finally the CCDM 44 adds a static identifier that uniquely identifies the user 20. The identifier is called a Personal Global Identifier (PGI) and may be used by any other user to reach that user. An example of the form of a PGI is PGI:username@example.com.

The DPC 43 also comprises another software module (not shown) that communicates with various “environment monitors” on the NAD 14. These monitors (which may be part of the operating system on the NAD 14) provide the DPC 43 with information such as the registered owner of the NAD 14, the type and quality of other services available on the NAD (such as audio and video) and the location of the device (if available). The DPC 43 stores data representing this information in the memory 36 of the NAD 14.

Once details of all of the communication entities, contact addresses, user environments, PGI and information from the environment monitors have been collated together and stored in the memory 36 as a contact identifier, the DPC 43 is now ready to register with the DPS 30.

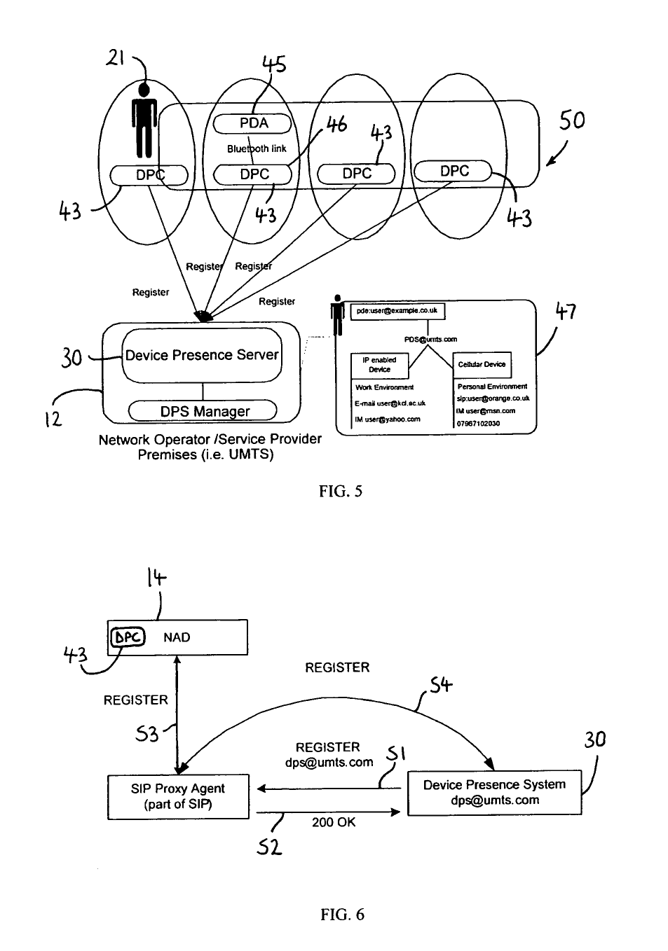

Referring to FIG. 5 a schematic representation of the registration procedure is generally identified by reference numeral 50. Each DPC 43 associated with a respective NAD registers with a DPS 30 as described below. The functionality and communication between the DPC 43, DPS 30 and DPSM 32 are analogous to that between a SIP (Session Initiation Protocol) client, SIP proxy and SIP registrar as described in RFC 2543 (available at www.ietf.org) and “Computer Networking” by Kurose and Ross (ISBN 0-203-97699-4) to which reference is specifically made in this respect.

In order to locate the contact address of the correct DPS (e.g. a SIP URI such as DPS@umts.com and DPS@dvb.com), the DPC 43 may use SIP mechanisms as described in RFC 2543. Prior to the registration procedure of the DPC 43, the DPS 30 will register with a local SIP proxy server, for example when a network operator installs the DPS software. In particular, referring to FIG. 6 a DPS 30 registers at step S1 with a local SIP proxy server using an identifier comprising URI characters (e.g. DPS@umts.com) that is unique within its network environment. At step S2 the DPS 30 sends a REGISTER message to the SIP proxy server by which the SIP proxy server knows at which address(es) the DPS 30 can be reached. The SIP proxy server responds with a 200 OK message.

As a result the DPC 43 only needs to locate the local SIP proxy server that will contain the contact address of the DPS 30. The local SIP proxy server can be found by the DPC 43 by a pre-configured SIP proxy address stored in the DPC 43, or using existing mechanisms as specified in RFC 3263 “Session Initiation Protocol (SIP): Locating SIP Servers” for example. In this way SIP can be utilised to start a session between the DPC 43 and the DPS 30, in which the DPC 43 can pass data to the DPS 30 representing the communication entities, the contact addresses, environment and PGI of the user 21, together with the information gathered from the environment monitors on the NAD 14. The DPC 43 uses the REGISTER method described in RFC 2543 to register this data with the DPS 30 (see FIG. 6 steps S3 and S4). The format for data transfer uses a protocol herein termed the “Terminal Description Protocol (TDP)”.

TDP is an application layer protocol for describing and communicating data representing the capability of terminals in terms of hardware and software. TDP uses SIP as its transport protocol. A TDP description of a terminal (or NAD) is given in structured text data representing the interfaces, communication entities and contact addresses available on that NAD. A structured text data format is preferred to other forms such as binary coding, since portability is enhanced, a variety of transport protocols can be used and flexible programming languages (such as C and Java) can be used to generate and process terminal descriptions. A terminal description takes a number of lines of text of the form <key>=<value>. <key> can be a series of characters and <value> contains a structured text string whose format depends on <key> and can be a number of fields delineated by a single space character or free format string. Each description consists of three parts: general terminal information, the terminal's communication means followed by the application's contact address. An example of a TDP description is shown below:—

t= Paul <PGI:paul@umts.com;137.73.11.45>
o=King's College London
d= Class A<audio;video;text>
l=strand;east wing;room E2
i1= GPRS
c1= 10 units
i2=WLAN
c2= 20 units
e=Home
a1=E-mail:paul.pangalos@umts.com
a2=IM:paulmj@yahoo.com
a3=FTP:137.73.11.45/7645

The various fields are as follows:

Terminal name: The ‘t’ field gives the name of the terminal followed by the PGI address. The IP address can also be given enabling the DPS 30 to communicate directly with the NAD 14 avoiding going back through the SIP proxy server.

The ‘o’ field gives the terminal owner's name.

Description: The ‘d’ field provides a description of the terminal in terms of classes. For example a Class A terminal might consists of a large colour screen with a high bandwidth connection, while class C might indicate a terminal with a limited display capabilities and a much lower bandwidth availability.

Location: the ‘1’ field provides details of the location of the NAD 14, if available. It is possible for the NAD 14 to estimate its location based on beacon signals from a Bluetooth access point, a WLAN access point or a cellular base station for example, all of which have a fixed location. Whilst the lower range (typically about 0-100 m radius) of Bluetooth and WLAN access points enables relatively accurate estimation, a cellular base station has a much greater range (up to several kilometres radius) and therefore may not be appropriate for such an estimate. Therefore the location field may be left blank where an estimate is not available or inaccurate.

Interface: The ‘i’ field is information about the terminal's interfaces. Terminals that are multi-mode (i.e. containing more than one interface) may be described by more than one ‘i’ field per TDP description. Each field describes the type of interface available on the terminal.

Cost: The ‘c’ field indicates the cost associated with using each interface.

Environment: The ‘e’ field specifies the user environment information that the network access device belongs to.

Applications: The ‘a’ field specifies available applications or communication entities on the terminal and the contact address(es) of each application. Applications contacts are specified using multiple instances of the ‘a’ field as shown in the example.

Further details of the TDP protocol can be found in Pangalos, P. and Aghvami, H., “The Terminal Description Protocol (TDP)”, WWRF8bis, China, 26-27 Feb. 2004 to which reference is made.

If the NAD is non-IP enabled, the DPC 43 acts as a gateway for that device to translate incoming messages into a form an application on the device can understand and vice versa. An example of a non-IP enabled device is a PDA 45 connected to a cellular phone 46 via Bluetooth.

As part of the registration procedure each DPC 43 of each NAD 14-20 sends a file (or message) generated by its respective CCDM 44 to the correct DPS 30 using the TDP protocol as described above. In the example shown in FIG. 5 there is only one network and therefore only one DPS 30. If there are several services on the NAD 14 each using a different home network (i.e. the NAD 14 is “multi-homed”), then the DPC 43 will register with the corresponding DPS on each of those networks. After the registration procedure is completed by a DPC 43 (on the or each network accessible by the NAD 14) the memory 27 of the network node 12 at the DPC 30 contains an electronic file 47 that comprises the aforementioned data representing the communication entities, contact addresses, environments and PGI of the user 21, together with information gathered from the environment monitors. It will be appreciated that if the NAD 14 is multi-homed, similar files will exist on each DPS of each network.

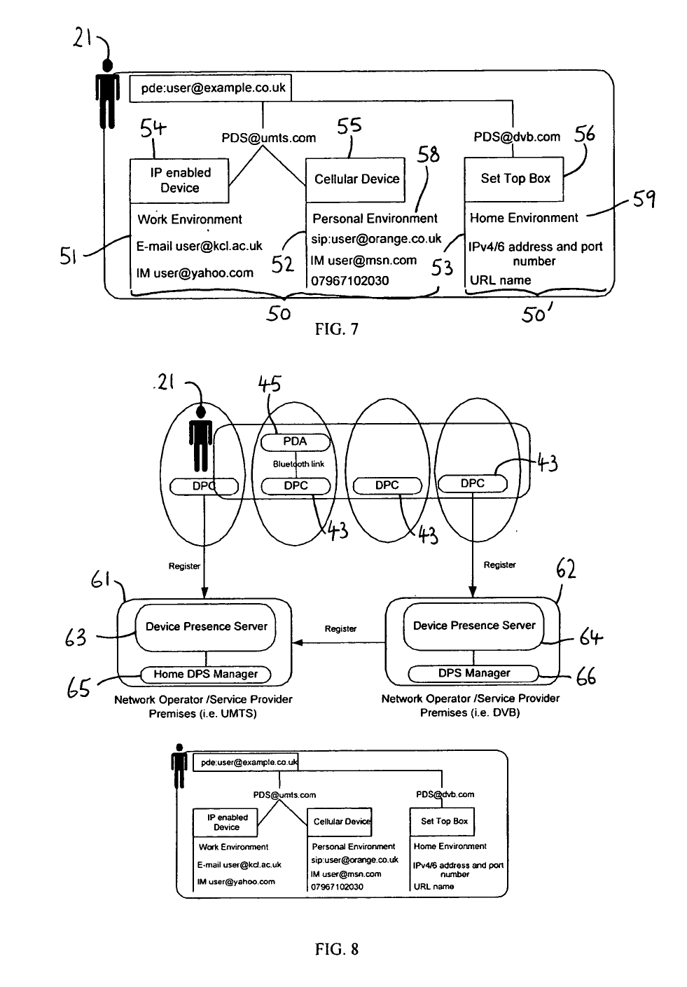

More frequently the user 21 will own or have access to a number of devices that use different, incompatible and/or separate and distinct networks (as shown in FIG. 1). In this case the DPC 43 of each device on each network will register with a respective DPS on the network used by that service on the NAD 14. Referring to FIG. 7 a schematic illustration of two electronic files generally identified by reference numeral 50 and 50′ (stored at two DPSs 30 respectively) contain data 51 and 52, and 53 respectively representing the communication entities and contact addresses of each application on each NAD of the user 21. Electronic file 50 is stored in the memory 27 of the network node 12, and electronic file 50′ is stored in the memory 27 of the network node 13. In this example the NADs of the user are an IP-enabled device 54, a cellular device 55 and a set top box 56. The user environments are a work environment 57, a personal environment 58 and a home environment 59 and the contact addresses have been divided according to these user environments. It is to be noted that the NADs are connected to two different networks as described above. Accordingly the DPC 43 of each NAD 54 and 55 reports to a DPS 30 associated with the UMTS network, whereas the DPC 43 of NAD 56 reports to a DPS 30 associated with the DVB network.

Referring to FIG. 8 a schematic representation of a multi-network registration procedure generally identified by reference numeral 60 illustrates the registration procedure of each DPC 43 when more than one network serves the NADs (only one shown—PDA 45) of the user 21. In this example two networks serve NADs of the user 21: a UMTS network 61 and a DVB network 62. Accordingly there are two DPSs 63 and 64, one associated with each network. A DPSM is located on each network node associated with each network or administrative domain. The DPSM is a set of computer executable instructions stored and executed on a network node associated with each of the networks 61, 62. The role of the DPSM is to provide a mapping between two or more DPSs. Furthermore, one DPSM is defined as the “Home” DPSM. This DPSM is associated with the home network of the user 21 i.e. that is responsible for billing, authentication and user profiles. The home network will usually be the domain that the PGI is associated with. For example, for PGI.paul@kcl.ac. uk, KCL will be the home network. The PGI address may be selected by the user. Whichever address is selected, the domain of that address determines the home network for that user.

Each DPSM may be a logical entity that is physically stored on the same network node as its associated DPS. However, if the DPSM is located on a physically different network node (for example if it is part of a SIP proxy server), then the DPS should be pre-configured by the network operator with the appropriate means (such as a hardware interface address) to contact and communicate with the DPSM. Furthermore, each DPS cannot communicate directly with another DPS. Communication is performed via the DPSMs that use the PGI to route messages over the Internet or other computer network. Since the form of the PGI is username@network com, messages from various DPSMs can be routed to the home DPSM using standard DNS procedures and IP routing mechanisms.

The function of each DPSM is to store a mapping between each PGI and the address of the Home DPSM associated with that PGI. In this way, each DPSM outside the home network of the user can route contact identifier from the DPS on that network to the DPS server on the home network via the Home DPSM. Additionally each Home DPSM will store a mapping between each PGI and (1) a list of the contact address(es) of DPSM(s) on other networks from which it has received and routed the contact identifier for that user to the DPS server on the home network; and (2) a list of the contact addresses of Home DPSMs of “buddies” of the user 21.

Referring still to FIG. 8 one DPC 43 registers with the DPS 63, which in turn registers with the Home DPSM 65. The contact identifier sent by the DPC 43 (using TDP as described above) is stored locally by the DPS 63 and is not sent to the Home DPSM 65. Another DPC 43 (on a NAD not registered on the home network) registers with the DPS 64. The DPS 64 registers with a DPSM 66 that, recognising that the domain of the PGI in the data does not match that of the local network operator, registers with the Home DPSM 65. Communication between the DPSM 66 and the Home DPSM 65 provides a means to send the data (representing communication entities, contact addresses etc. for all of the applications on all of the devices of the user 21 over the DVB network) from the DPS 64 to the DPS 63. The SUBSCRIBE and NOTIFY messages described in RFC 3265 (available on www.ietf.org) can be used for signalling between the DPSMs i.e. the DPSM 66 can send a SUBSCRIBE message to the Home DPSM 65 that acknowledges the subscription in a NOTIFY message. In this manner the Home DPSM 65 routes data representing the contact addresses of the user 21 for all of the applications on all of his or her devices on all networks to the DPS 63 on the home network.

By separating the functions of the DPSs and the DPSMs, the DPSMs can be logically and physically distinct from the DPSs. For example a DPS may be stored and run on a server of the network operator and the functionality of a DPSM may be easily added to a SIP proxy server for example that may be remote from the server storing the DPS.

The data stored at the DPS 63 on the home network is kept substantially current by means of updates transmitted from DPSMs on other networks of NADs used by the user 21. Updates should be triggered when the environment of a NAD device changes, for example: a PDA looses communication with a Bluetooth device having an interface address (BD_ADDR) known to be in the home environment of the user; some time afterwards the PDA may commence communication with a Bluetooth device having an interface address known to be in the office environment of the user. At each instance, the DPC on the PDA will transmit an update to the DPS on the cellular network for example, that will in turn transmit the update to the DPS on the user's home network. Updates will also be triggered when status of services on the NAD change (e.g. “offline”, “online”, “busy”) and when a lifetime of the registration between the DPC and DPS is about to expire. Typically such lifetimes will be of the order of about 30 minutes to a few hours for cellular networks, and between about 1 minute and about 60 minutes for other networks.

Since the Home DPSM of the user contains a mapping between the PGI of that user and the DPSMs of the user's buddies, any updates in the contact identifier for that user can be transmitted to the Home DPSM associated with each buddy, thereby keeping the buddies up to date with a contact identifier comprising one or more of (a) different communication entities (services) by which the user 21 may be contacted, (b) the contact addresses for contacting the user 21 on those services, and (c) the interfaces by which the user may be contacted. Furthermore the contact identifier may comprise, with any of (a), (b) and/or (c) presence data of the user of those services, for example “online”, “busy”, etc.

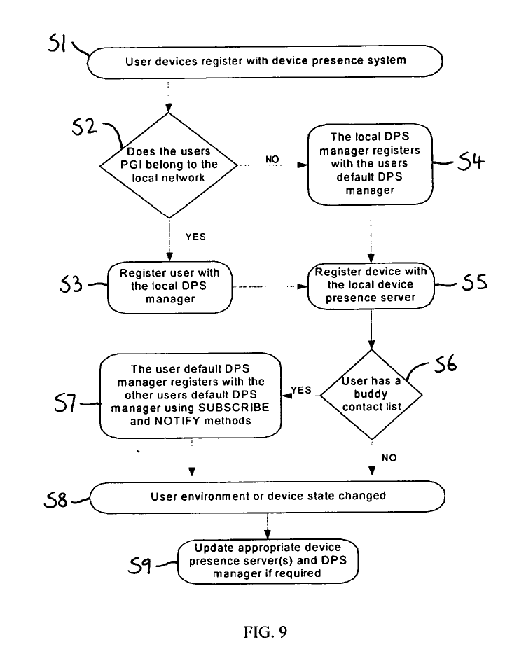

Referring to FIG. 9 a flow chart generally identified by reference numeral 70 shows various steps in a method for users to discover and track their own devices (or those to which they are logged on for example), as well as devices of other users. At step S1 each DPC 43 running on each NAD 14-20 of the user 21 gathers contact address, communication entity, PGI and environment monitor (CCPEM) data therefrom and registers with the DPS associated with the network that serves each NAD as described above. At step S2 each DPS takes the PGI from each registration and checks whether that PGI belongs to that network i.e. whether or not the PGI has the same domain. If it does, the PGI is registered with the local DPSM at step S3, and the method proceeds to step S5 where the CCPEM data is stored locally in a database on the DPS server. If not, at step S4 the DPS informs the local DPSM that there is a non-local PGI. The local DPSM looks up (e.g. with DNS lookup) the interface of the Home DPSM associated with the PGI, and then sends that Home DPSM a REGISTER message as described above. Once the local DPSM has received an acknowledgement in the form of a NOTIFY message from the Home DPSM, the CCPEM data is routed from the local DPS to the DPS on the home network via the local DPSM and Home DPSM, and the method performs step 5 described above. At step S6 the Home DPSM checks whether the user has a “buddy” list i.e. a list of other users with whom he or she likes to be informed of the other users' presence and means of contact and vice versa. If yes, at step S7 the Home DPSM registers with the buddies’ respective Home DPSMs using the REGISTER and NOTIFY messages as described above. In this way the Home DPSM ensures that a means of communication is established between the DPSs of the user's buddies and the DPS of the user 21.

At setup (i.e. when first establishing the record of the user 21 in the database) when the user 21 has a buddy list (or when a new buddy joins), the Home DPSM of user 21 transmits to each Home DPSM of each buddy (or the new buddy) the record for user 21 from the database i.e. all of the contact addresses (known at that point in time) for the user 21 over all the networks to which the user 21 has access via the NADs 14-20. The Home DPSM of each buddy then forwards this data to the local DPS associated therewith. The local DPS may simply forward this data to the NAD of the buddy, or may store it locally for remote access by that NAD. In this way the buddies of the user 21 can obtain his contact identifier over the various services and networks. If the local DPS of the user 21 receives an update from one of the NADs of that user (e.g. service taken offline) then the change in the database triggers the Home DPSM to notify all of the Home DPSMs of the user's buddies of the update. In this way the buddies of the user 21 are kept up to date with his/her contact addresses. The record and updates are sent using the TDP message format described above with SIP as the transport. Alternatively it would be possible for DPSMs to join and leave multicast groups i.e. each user would be associated with a multicast group IP address by means of which members of the group could be kept up to date with the contact addresses for that user. The local DPS of the user 21 may also respond to one off queries from other users on the same or other networks who are not buddies of the user 21. These other users may be customers of the user 21 for example. Ideally the query is in the form of the PGI of the user 21, although it may be any of the contact addresses known to the other user. On receiving a query from another user the local DPS may lookup and transmit the record of user 21 to the Home DPSM that sends it on to the Home DPSM of the enquiring user. The user 21 may adjust settings at the DPS such that only certain contact addresses are returned for one off enquiries, whereas the same and/or different contact addresses are returned for buddies of the user 21. For one off enquiries the enquiring user will receive the most recent contact identifier for contacting a business for example, which may provide a number of options for contacting that business. The method then proceeds to step S8.

If at step S6 the user does not have a buddy list, the method proceeds directly from step S6 to step S8 in which the DPC of each NAD monitors the communication entities and user environment. At setup the NAD that the user 21 is using may register with the Home DPSM that responds by sending the user's record from the database in the local DPS to the DPSM associated with that NAD. In this way the user 21 may be advised of and monitor all of the contact addresses of all of the services on his NADs 14-20. If there is a change in the state of a NAD, for example an application is opened or shut down or if the user environment changes, the DPC triggers at step S9 a registration update in which it sends the latest information from that NAD to the DPS, which update is handled as described above. Once the local DPS updates the database this triggers the Home DPSM to transmit the updated part of the record to the DPSM associated with the NAD that the user is using. It is possible that the DPC will send an update periodically if there has been no other change, or if requested by a DPS. Depending on the interface this period may be relatively long or relatively short. For example, if the interface of the NAD is GPRS (General Packet Radio Service) then the period may be relatively long (e.g. between about 30 minutes and a few hours) since the cost (both financially and in terms of the radio resource) of that interface is relatively high. Conversely if the NAD has a wired broadband interface then the period may be relatively short (e.g. between about 1 minute and about 60 minutes). After this, all other users interested in the user 21 are updated with the new contact address(es) and/or status information for all NADs of the user 21.

If a NAD becomes unavailable the DPC will de-register with the local DPS by sending a registration request with a zero lifetime. The DPS will de-register that NAD and update the relevant DPSM, which in turn will inform the relevant other DPSM(s). If all NADs at a user's home network go offline, the remaining NADs of the user available on other networks will still be visible to other users as the DPSM on the home network should not stop functioning. If all user NADs on all networks are offline, the DPSM on the home network will advertise offline contact addresses such as an e-mail address, telephone number, voice mail, or mobile telephone number for text messaging.

In this way communication entity (or service) and contact address presence information may be passed between heterogeneous networks substantially simultaneously, whereby the user 21 may discover and track all or some of the communication entities of his or her devices remotely, and other users may do the same. Another user wishing to contact the user 21 may see either all of the devices, services interfaces and/or contact addresses of the user 21 or only those that the user 21 wishes to be visible. The other user may then choose which communication entity/contact address suits best for contacting the user 21.

In a heterogeneous network environment users have the choice of connecting a NAD to a diversity of different networks (usually by wireless link). NADs detect the different networks from beacon signals from base stations, etc. of the different networks. A user can choose which network to connect to based on signal strength for example. However, such a method is user centric i.e. based only on parameters within the user's device, and does not take into account network related information such as cost and bandwidth. Thus by selecting a network based on signal strength there is no guarantee that the user will have a higher throughput of data, or cheaper connection for example.

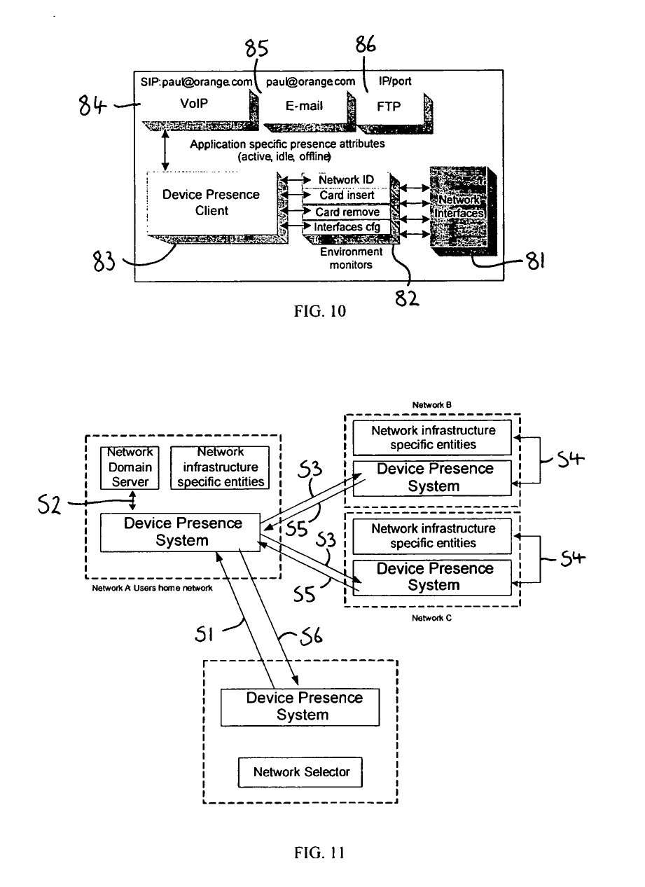

Referring to FIG. 10 a NAD generally identified by reference numeral 80 is similar to the NAD shown in FIG. 3. The NAD 80 comprises a number of network interfaces. An application 82 stored in memory 36 provides an environment monitoring function when executed on the CPU 37. For example the application 82 may monitor whether a card (e.g. wireless network interface card) is inserted or removed from the device 80, may retrieve the ID of a network that a service uses and may gather interface configuration parameters. These tasks may be performed by the operating system (e.g. Linux) stored on the NAD 80. The application 82 reports this data to the DPC 83. The following data is gathered and reported: interface name (i.e. name given to interface by operating system such as eth0, ppp0, dvb0), type (e.g. Bluetooth, Ethernet, W-LAN, Broadcast), status (e.g. online, offline, not configured, configured), ID name (i.e. name of the access point with which the interface communicates), IP address and MAC address of the interface (if available). For example:

Interface eth1, WLAN, online, ESSID: KCL, 137.73.11.96, DE-2E-AB-44-32-BC

The DPC 83 also extracts data from the communication entity (i.e. a service comprising one or more application) such as Voice over IP (VOIP) 84, e-mail 85 and FTP 86 that are stored and can be run on the device 80. Such data includes presence attributes (e.g. active, idle, offline) and the contact address of the communication entity.

The NAD 80 performs a network selection function using a network centric approach to choose or recommend a network to a user. The network selection function operates by taking input both from user terminals and the networks to decide which is the best network to use for a given service.

The network selection function comprises the following steps:—

(1) DPC network discovery where the DPC generates a list of available networks via the NAD 80;

(2) DPC communicates with local DPS asking for network recommendation for services on the NAD 80;

(3) local DPS communicates with other device presence servers on other networks and decides which network is best for each application on the device;

(4) DPS reports to DPC with network list report; and

(5) DPC instructs application to connect to appropriate network.

During step (1) the DPC 83 activates all available network interfaces on the device and records all of those that are available at the present location. The data representing the list is stored in the memory 27. The list includes the following information:—

(a) Network ID: used to uniquely identify each network (e.g. DVB-H, UMTS, WLAN);

(b) Network specific information: this information is needed for step (3) above. For WLAN access points this information would be the SSID or ESSID (Service Set ID or Extended SSID) and MAC address; for DVB networks the information would be the DVB cell ID; and for cellular networks it is the cell ID.

(c) Communication identifiers that uniquely identify the desired user services (such as e-mail, VoIP, FTP, Web-browsing, Instant Messaging, Video, Audio). Each identifier should also include a set of Quality of Service (QoS) parameters that are desired for each service or application. These include: service class (streaming, interactive, voice, background), maximum bit rate and maximum cost. Some of these parameters may be set by the user.

A Network ID is assigned to each network operator. For example, cellular network operators have a unique Network ID assigned to them by a government. In the UK the cellular network operator Vodafone has the Network ID 234 15. The network operator Orange has the Network ID 234 33. Further details of network operators all over the world are presently available at http://www.gsmworld.com/roaming/gsminfo/index.shtml. A WLAN has a Network ID called a Service Set Identifier (SSID) that is a 32 character unique identifier that differentiates one WLAN from another. A DVB network operator has a Network ID that serve as unique identification codes for DVB networks. Each DVB network transmits a Network Information Table (NIT) that carries dynamically updated network and transponder specific information (network name ID, frequencies, code rates etc.) for all transponders of the network. A NIT is transmitted every 10 s or less. For example a NIT for Digita Finland comprises the following:—

Network Name: [0]Digita Finland

Transport Stream ID:0x1001

Original Network ID:0x20F6

Bandwidth: 8 MHz

Constellation: 64 QAM

Hierarchy Information: Non Hierarchical

Code Rate: ⅔

Guard Interval: ⅛

Transmission Mode: 8K

Whatever the particular form of the Network ID it is usually broadcast by each network operator and is received and read by NADs so that they can know whether or not they are attached to their home network.

Once this information is obtained, the DPC 83 generates the network list report in which the available networks are placed in preferred order based on the information above and the signal strength for each network, terminal and user related information such as user profiles and battery life.

Referring to FIG. 11 at step (2) above the data (representing the preferred network order and the associated preferred parameters) is sent to the local DPS i.e. the device presence server within the user's home network using a suitable message format and transport protocol (step S1 FIG. 11; examples of a suitable message format and transport protocol include XML format using TCP/IP, SIP using WAP or a specific text message format transported over SMS).

The NAD 14 can only obtain the limited information about each of the networks it can access. In particular, the NAD 14 can identify the network operator in terms of the Network ID it receives (as explained above), but is unable to obtain any data regarding a means for the local DPS to communicate with the other networks that are available to the NAD 14. Thus a means is needed for the local DPS to discover an interface on the other networks to which it can send data to cause the other networks to determine whether or not they can meet the QoS requirements, etc. and to respond to the local DPS.

At step S2, the local DPS now interacts with a logical entity herein referred to as a “Network Domain Server” (NDS). The function of the NDS is to provide a mapping between the Network ID (e.g. the name of the network given in the network list report) and network address data such as the IP or URI address of a DPS on each other network in the network list report. The NDS is stored in the form of computer executable instructions in the memory 27 of the network node 12 in the network infrastructure 11. Electronic data is also stored in the memory 27 that represents the Network ID and a mapping to the network address data (IP or URI address) of other DPSs on other networks. The electronic data is input manually when the network node is configured with the NDS functionality. A network operator will input each Network ID and the IP or URI address of the DPS associated with that Network ID. The electronic data may be stored in the form of a database. The computer executable instructions enable the NDS to handle queries in terms of the Network ID and search the database for that entry. Once found the associated network address data (IP or URI address) can be looked up and returned in response to the query. Once a first database of this kind has been set up, it may be possible for the network operators to electronically distribute this information between themselves so that inputting of data does not have to be repeated. If an NDS receives an update, it may automatically send an update to all of the other networks in its database.

When the NDS receives a query from the local DPS, it searches the database of the aforementioned fields to see if it stores the IP or SIP URI of other DPSs in the network list report. The addresses found are sent to the local DPS that raised the query. In this way the local DPS obtains an IP/URI address of the other DPSs on the other networks. An NDS record takes the form of:

### Network_ID, Cell_ID, Destination_endpoint

### Example: BBC_DVB_H, Edmonton_A3, 137.73.11.96/dps:edmn@bbcl.com

It is possible that a network may use multiple DPSs, each allocated to serve a specific number of cells but each located at the same IP/URI address. In that case the Cell_ID parameter may be used to select the correct destination endpoint. The NDS is not constrained to storing only those parameters mentioned above. It may also store details of other network entities such as Resource Managers, network gateways, home subscriber server (HSS), etc. Such details may also be input manually into the database as described above.

At step (3) above and step S3 FIG. 11 the Home DPSM of the local DPS sends to all of the DPSMs on the other networks in the list a Service Information Request message containing data representing the required service on that network, service type, preferred QoS parameters and cost. The messages are routed over the Internet to the DPSs on the other networks above as described herein. In response at step S4 the DPSs contact their own specific network entities to determine what kind of service that network can offer against the communication identifiers that were sent. At step S5 each other network replies the local DPS via the Home DPSM with a Service Information Reply message containing data indicating what services can be offered based on the communication identifiers mentioned above and the resources available on that network. Examples of the communication identifiers that might be taken into consideration are cost, quality of service and current load of the network, Further details of one way the other heterogeneous networks might determine this resource allocation and interact with the local DPS can be found in Huang, Chew and Tafazolli, “Distributed Resource Management for Interworking of Cellular and Digital Broadcasting Networks”, IST Summit 2004, June 27-30, Lyon, France.

Based on the messages received the local DPS will generate and store in memory a new network report ranking the networks based on the communication identifiers preferred by the user and/or the NAD 80. The new network report contains additional information: network specific information that will help the device 80 communicate with the new network. Such network specific information may be the PID (Packet ID) number for a DVB receiver to listen to or the channel number for a WLAN. The network report is sent to the DPC 83 in a Service Reply message at step S6.

At step (5) above the DPC 83 selects the appropriate network interface and starts the application associated with that service.

In order to implement the invention, it will be apparent from the foregoing that various changes will need to be made to network nodes owned and/or operated by the network operators. Computer executable instructions for performing the methods and giving rise to the various logical entities described herein may be installed on various computer servers to this end.

It will also be apparent that various changes will need to be made to the network access devices. Those devices already in use will need to be upgraded to receive and install computer executable instructions for performing the methods and giving rise to the logical entities needed on each network access device. The upgrade may be provided from the network operator in the form of a download over the network, or may be provided on a memory means such as a CD-ROM, flash memory, etc. for installation by a user. For new devices, the manufacturing process may comprise the step of installing such computer executable instructions, for example by uploading the instructions to a memory means on the NAD or by insertion and connection of suitable pre-programmed memory means (e.g. integrated circuit) in the NAD.

Although the embodiment of the invention described with reference to the drawings comprises computer apparatus and methods performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the methods according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal that may be conveyed via electrical or optical cable or by radio or other means.

When the program is embodied in a signal that may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant methods.

What is claimed is:

1. A method of discovering a contact identifier by which data may be sent over one or more electronic data communication network toward one or more network access device used by a user, which method comprises the steps of:
(a) electronically collecting a contact identifier from said one or more network access device, and storing said contact identifier in memory, which contact identifier provides an indication of the addressing option(s) available on the or each network access device;
(b) generating an electronic database comprising or comprising a reference to said contact identifier; and
(c) providing access to said electronic database whereby said user and/or another user may obtain said contact identifier, whereby said user and/or another user may discover said addressing option(s) to facilitate transmission of data toward said one or more network access device.

2. A method according to claim 1, wherein said contact identifier comprises substantially all of the currently available addressing options available on the or each network access device of said user.

3. A method according to claim 1, further comprising the step of mapping a static identifier (PGI) of said user to said contact identifier, whereby said electronic database comprises a mapping between a user and one or more ways of sending/receiving data to/from said user over one or more electronic data communication network.

4. A method according to claim 3, further comprising the step of storing in said electronic database a mapping between said static identifier and one or more buddy of said user, whereby a network access device of said one or more buddy may access and/or receive said contact identifier from said electronic database so that said one or more buddy may be informed of said contact identifier for said user.

5. A method according to claim 1, further comprising the steps of monitoring said contact identifier with time, and updating said contact identifier in said electronic database upon detection of a change in status of said addressing option(s).

6. A method according to claim 1, wherein the or each network access device of a user performs said collection step of step (a).

7. A method according to claim 6, wherein said collection step comprises the steps of (i) receiving or otherwise obtaining from a communication entity on said network access device, which communication entity provides a means for transmitting data to and receiving data from an electronic data communication network, an entity identifier of said communication entity and a contact address for contacting said user via that communication entity, and (ii) storing said data in a memory as said contact identifier.

8. A method according to claim 6, further comprising the step of monitoring said network access device for the addition and removal of a communication entity therefrom, and upon addition or removal thereof transmitting an electronic update message to the or each electronic data communication network accessible by that communication entity.

9. A method according to claim 1, wherein a network node in communication with said electronic data communication network performs step (b).

10. A method according to claim 9, wherein step (b) comprises the steps of receiving on a first electronic data communication network said contact identifier from a network access device, which contact identifier is accompanied by a static identifier (PGI) of said user, and determining whether or not said first electronic data communication network is a home network of said user.

11. A method according to claim 10, further comprising the step of if said first electronic data communication network is said home network, storing said contact identifier in a memory and adding said contact identifier to said electronic database.

12. A method according to claim 10, further comprising the steps of storing a mapping between said static identifier and a list of one or more buddy of said user, and upon receipt of said contact identifier, transmitting or otherwise making accessible said contact identifier to said one or more buddy.

13. A method according to claim 1, further comprising the step of assisting network selection for a multi-mode access device by sending electronic requests to the electronic data communication networks accessible by that device, which electronic requests each comprise parameters required by said multi-mode network access device and a network identifier of each electronic data communication network accessible from that device, and awaiting responses from said electronic data communication networks.

14. A method according to claim 13, further comprising the step of generating a network selection electronic message comprising a list of electronic data communication networks accessible from that network access device, and transmitting said network selection electronic message to an electronic data communication network accessible by that device.

15. A method according to claim 14, further comprising the step of electronically searching a network database for a network contact for contacting each of said electronic data communication networks, which network database comprises a mapping between said network identifier of each electronic data communication network and said network contact.

16. A method according to claim 14, further comprising the step of generating a network reply electronic message comprising a list of electronic data communication networks ranked by ability to meet said parameters, and transmitting said network reply electronic message to said multi-mode access device.

17. A network access device for use in a method of discovering a contact identifier by which data may be sent over one or more electronic data communication network toward one or more network access device used by a user, which method comprises the steps of:
(a) electronically collecting a contact identifier from said one or more-network access device, and storing said contact identifier in memory, which contact identifier provides an indication of the addressing option(s) available on the or each network access device;
(b) generating an electronic database comprising or comprising a reference to said contact identifier; and
(c) providing access to said electronic database whereby said user and/or another user may obtain said contact identifier, whereby said user and/or another user may discover said addressing option(s) to facilitate transmission of data toward said one or more network access device;
said network access device comprising a memory storing computer executable instructions for electronically collecting a contact identifier and storing said contact identifier in memory, which contact identifier provides an indication of the addressing option(s) available on that network access device.

18. A network node for use in a method of discovering a contact identifier by which data may be sent over one or more electronic data communication network toward one or more network access device used by a user, which method comprises the steps of:
(a) electronically collecting a contact identifier from said one or more network access device, and storing said contact identifier in memory, which contact identifier provides an indication of the addressing option(s) available on the or each network access device;
(b) generating an electronic database comprising or comprising a reference to said contact identifier; and
(c) providing access to said electronic database whereby said user and/or another user may obtain said contact identifier, whereby said user and/or another user may discover said addressing option(s) to facilitate transmission of data toward said one or more network access device;
said network node comprising a memory storing computer executable instructions for generating an electronic database comprising or comprising a reference to said contact identifier.

19. A network node for use in a method of discovering a contact identifier by which data may be sent over one or more electronic data communication network toward one or more network access device used by a user, which method comprises the steps of:
(a) electronically collecting a contact identifier from said one or more network access device, and storing said contact identifier in memory, which contact identifier provides an indication of the addressing option(s) available on the or each network access device;
(b) generating an electronic database comprising or comprising a reference to said contact identifier; and
(c) providing access to said electronic database whereby said user and/or another user may obtain said contact identifier, whereby said user and/or another user may discover said addressing option(s) to facilitate transmission of data toward said one or more network access device;
said network node comprising a memory storing computer executable instructions for storing a mapping between said static identifier and a list of one or more buddy of said user, and upon receipt of said contact identifier, transmitting or otherwise making accessible said contact identifier to said one or more buddy.

20. In a first electronic data communication network having a first interface, a method of identifying a second interface in a second electronic data communication network, to which second interface data is to be sent from said first interface, which method comprises the steps of:—
(a) receiving on said first electronic data communication network electronic data representing a network identifier of said second electronic data communication network, which network identifier uniquely identifies an operator of said second electronic data communication network;
(b) electronically searching for said network identifier in an electronic database comprising data organised into a network identifier field and an address field, which electronic database provides a mapping between each network identifier and a respective address of an interface associated with that network identifier; and
(c) if said network identifier is located, providing an output signal comprising an address of said second interface, whereby data may be sent from said first interface to said second interface.

21. A method according to claim 20, wherein said first electronic data communication network and said second electronic data communication network are under different administrative domains respectively.

22. A network node for use in a method of identifying in a first electronic data communication network having a first interface, a second interface in a second electronic data communication network, to which second interface data is to be sent from said first interface, which method comprises the steps of:—
(a) receiving on said first electronic data communication network electronic data representing a network identifier of said second electronic data communication network, which network identifier uniquely identifies an operator of said second electronic data communication network;
(b) electronically searching for said network identifier in an electronic database comprising data organised into a network identifier field and an address field, which electronic database provides a mapping between each network identifier and a respective address of an interface associated with that network identifier; and
(c) if said network identifier is located, providing an output signal comprising an address of said second interface, whereby data may be sent from said first interface to said second interface.
said a network node comprising means storing computer executable instructions for performing steps of:—
(i) receiving on a first electronic data communication network electronic data representing a network identifier of a second electronic data communication network, which network identifier uniquely identifies an operator of said second electronic data communication network;
(ii) electronically searching for said network identifier in an electronic database comprising data organised into a network identifier field and an address field, which electronic database provides a mapping between each network identifier and a respective address of an interface associated with that network identifier; and
(iii) if said network identifier is located, providing an output signal comprising an address of said second interface, whereby data may be sent from said first interface to said second interface.

23. A method of assisting network selection for a multi-mode network access device, which method comprises the steps of:—
(a) gathering data representing available interfaces on said multi-mode network access device, each interface permitting communication with a respective electronic data communication network;
(b) composing and transmitting an electronic message comprising a network identifier for each electronic data communication network accessible from that device, which electronic message is transmitted to a home electronic data communication network of said multi-mode network access device;
(c) receiving on said home electronic data communication network electronic data representing said network identifier(s);
(d) electronically searching for said network identifier(s) in an electronic database comprising data organised into a network identifier field and an address field, which electronic database provides a mapping between each network identifier and a respective address of an interface associated with that network identifier on that electronic data communication network; and
(e) if said network identifier(s) is located, providing an output signal comprising an address of the or each other interface;
(f) said home electronic data communication network transmitting a request to the or each interface, which request message causes each electronic data communication network to determine an ability serve said multi-mode network access device and to respond to said home electronic data communication network accordingly;
(g) said home electronic data communication network composing and transmitting to said multi-mode network access device a response message comprising data representing said ability of each electronic data communication network accessible from said multi-mode network access device; and
(h) said multi-mode network access device awaiting said response from said electronic data communication network;
whereby on receipt of said response said multi-mode network access device or a user thereof may select one of said electronic data communication networks for a service on said multi-mode network access device based on data in said response.

24. A method according to claim 23, wherein said multi-mode network access device further performs the step of gathering and transmitting in said electronic message a communication identifier that uniquely identifies a service desired by a user, and said request transmitted by said home electronic data communication network comprises said communication identifier, whereby the other electronic data communication networks determine an ability to provide said desired service.

25. A method according to claim 24, wherein said communication identifier identifies a service such as e-mail, Voice over IP, File Transfer Protocol, Web-browsing, Instant Messaging, Video and Audio.

26. A multi-mode network access device for use in a method of assisting network selection for a multi-mode network access device, which method comprises the steps of:—
(a) gathering data representing available interfaces on said multi-mode network access device, each interface permitting communication with a respective electronic data communication network;
(b) composing and transmitting an electronic message comprising a network identifier for each electronic data communication network accessible from that device, which electronic message is transmitted to a home electronic data communication network of said multi-mode network access device;
(c) receiving on said home electronic data communication network electronic data representing said network identifier(s);
(d) electronically searching for said network identifier(s) in an electronic database comprising data organised into a network identifier field and an address field, which electronic database provides a mapping between each network identifier and a respective address of an interface associated with that network identifier on that electronic data communication network; and
(e) if said network identifier(s) is located, providing an output signal comprising an address of the or each other interface;
(f) said home electronic data communication network transmitting a request to the or each interface, which request message causes each electronic data communication network to determine an ability serve said multi-mode network access device and to respond to said home electronic data communication network accordingly;
(g) said home electronic data communication network composing and transmitting to said multi-mode network access device a response message comprising data representing said ability of each electronic data communication network accessible from said multi-mode network access device; and
(h) said multi-mode network access device awaiting said response from said electronic data communication network;
said multi-mode network access device comprising a memory storing computer executable instructions for performing the steps of:—
(i) gathering data representing available interfaces on said multi-mode network access device, each interface permitting communication with a respective electronic data communication network;
(ii) composing and transmitting an electronic message comprising a network identifier for each electronic data communication network accessible from that device, which electronic message is transmitted to a home electronic data communication network of said multi-mode network access device; and
(iii) said multi-mode network access device awaiting said response from said electronic data communication network;
whereby on receipt of said response said multi-mode network access device or a user thereof may select one of said electronic data communication networks for a service on said multi-mode network access device based on data in said response.

27. A network node for use in a method of assisting network selection for a multi-mode network access device, which method comprises the steps of:—
(a) gathering data representing available interfaces on said multi-mode network access device, each interface permitting communication with a respective electronic data communication network;
(b) composing and transmitting an electronic message comprising a network identifier for each electronic data communication network accessible from that device, which electronic message is transmitted to a home electronic data communication network of said multi-mode network access device;
(c) receiving on said home electronic data communication network electronic data representing said network identifier(s);
(d) electronically searching for said network identifier(s) in an electronic database comprising data organised into a network identifier field and an address field, which electronic database provides a mapping between each network identifier and a respective address of an interface associated with that network identifier on that electronic data communication network; and
(e) if said network identifier(s) is located, providing an output signal comprising an address of the or each other interface;
(f) said home electronic data communication network transmitting a request to the or each interface, which request message causes each electronic data communication network to determine an ability serve said multi-mode network access device and to respond to said home electronic data communication network accordingly;
(g) said home electronic data communication network composing and transmitting to said multi-mode network access device a response message comprising data representing said ability of each electronic data communication network accessible from said multi-mode network access device; and
(h) said multi-mode network access device awaiting said response from said electronic data communication network;
said network node comprising a memory storing computer executable instructions for performing the steps of:—
(i) receiving on a home electronic data communication network electronic data representing a network identifier of another electronic data communication network, which network identifier uniquely identifies an operator of said other electronic data communication network;
(ii) electronically searching for said network identifier in an electronic database comprising data organised into a network identifier field and an address field, which electronic database provides a mapping between each network identifier and a respective address of an interface associated with that network identifier; and
(iii) if said network identifier is located, providing an output signal comprising an address of said second interface, whereby data may be sent from said first interface to said second interface;
(iv) repeating steps (a) to (c) to identify an address of an interface in each electronic data communication network accessible by said multi-mode network access device;
(v) said home electronic data communication network transmitting a request to said address of each interface in each electronic data communication network accessible by said multi-mode network access device, which request message causes each electronic data communication network to determine an ability serve said multi-mode network access device and to respond to said home electronic data communication network accordingly;
(vi) said home electronic data communication network composing and transmitting to said multi-mode network access device a response message comprising data representing said ability of each electronic data communication network accessible from said multi-mode network access device; and
whereby on receipt of said response said multi-mode network access device or a user thereof may select one of said electronic data communication networks for a service on said multi-mode network access device based on data in said response.
